(19) United States
(12) Patent Application Publication
(10) Pub. No.: US 2002/0010846 A1
(43) Pub. Date: Jan. 24, 2002

(54) Method for changing the execution of a program stored in a read only memory

(76) Inventors: Michael Weber, Freising (DE); Johann Steger, Munchen (DE)

Correspondence Address: LERNER AND GREENBERG P.A., POST OFFICE BOX 2480, HOLLYWOOD, FL, 33022-2480, US

(21) Appl. No.: 09/882,730

(22) Filed: Jun. 15, 2001

Related U.S. Application Data
(63) Continuation of application No. PCT/DE99/03830, filed on Dec. 1, 1999.

(30) Foreign Application Priority Data
Dec. 15, 1998 (DE) 198 57 921.7

(51) Int. Cl. G06F 12/00

(52) U.S. Cl. 711/165; 717/11

(57) ABSTRACT

A method for changing the execution of a program stored in a read only memory is described. For this purpose, the program has a multiplicity of program routines, and each program routine can be allocated a subprogram that is stored in a first read/write memory. In addition, each program routine has associated memory locations in a second read/write memory. If a program routine has an associated subprogram, the program routine then calls the subprogram on the basis of the content of the associated memory locations.

### CROSS-REFERENCE TO RELATED APPLICATION

This application is a continuation of copending International Application No. PCT/DE99/03830, filed Dec. 1, 1999, which designated the United States.

### BACKGROUND OF THE INVENTION

### Field of the Invention

The invention relates to a method for changing the execution of a program stored in a read only memory. The program has a multiplicity of program routines and each program routine can be allocated a subprogram that is stored in a read/write memory.

Many integrated circuits containing a microprocessor and/or a signal processor have a read only memory (ROM) for programs for the microprocessor or signal processor (firmware). By way of example, in an integrated circuit for a mobile radio telephone based on the global system for mobile communications (GSM) standard, functions for voice processing, channel coding and for data services are implemented in programs for a signal processor, and functions for controlling the telephone are implemented in programs for a microprocessor. For retrospective changes to the programs, at least one mask for producing the integrated circuit needs to be changed, and the integrated circuit needs to be produced again. This is complex and expensive, particularly in the case of mass production of integrated circuits.

By way of example, U.S. Pat. No. 5,493,674 discloses the practice of inserting instructions at prescribed locations in a program stored in a read only memory. The instructions call a respective subprogram (patch correction program). In this case, the subprogram is stored in a read/write memory (RAM=Random Access Memory) and can be changed retrospectively.

The advantage in this case is that changing the subprograms stored in the read/write memory allows retrospective influencing of the execution of the program stored in the read only memory. To this end, the read/write memory is loaded with the subprograms for correcting the read only memory program by apparatuses that are not included on the integrated circuit.

Once the subprogram has been executed, execution returns to the program stored in the read only memory.

However, a disadvantage is that execution always jumps from the current program to the subprograms. In addition, precisely one subprogram is provided for each instruction for calling a subprogram. Therefore, the subprograms sometimes have a high memory space requirement. These restrictive boundary conditions mean that retrospective changes to the program stored in the read only memory are possible only to a limited extent.

International Patent Disclosure WO 94 27220 A describes a method for changing the execution of a program stored in a ROM. In this case, all the locations at which changes would be possible are first found in an object file. A first table is then produced on this basis and, after comparison between the original object code and the changed object code, another table (symbol table) is produced which refers to the locations to be used as the basis for execution of a changed program code.

### Summary of the Invention

It is accordingly an object of the invention to provide a method for changing the execution of a program stored in a read only memory which overcomes the above-mentioned disadvantages of the prior art methods of this general type, in which the subprogram calls can be influenced retrospectively and, at the same time, the memory space requirement needed for the subprograms is as low as possible.

With the foregoing and other objects in view there is provided, in accordance with the invention, a method for changing an execution of a program. The method includes the step of providing a read only memory having the program stored therein. The program has a multiplicity of program routines and each of the program routines can be allocated a subprogram stored in a first read/write memory. Each of the program routines has associated memory locations located in a second read/write memory, and if a respective program routine has an associated subprogram, the respective program routine calls the associated subprogram on a basis of a content of the associated memory locations.

The invention relates to a method for changing the execution of a program stored in a read only memory. For this purpose, the program has a multiplicity of program routines, and each program routine can be allocated a subprogram that is stored in a first read/write memory. Accordingly, it is possible for each program routine to have an associated dedicated subprogram, for a plurality of program routines to have an associated common subprogram, or for no program routine to have an associated subprogram. In this context, only if the program stored in the read only memory is free of errors will no program routine have an associated subprogram. Each program routine additionally has associated memory locations in a second read/write memory. If a program routine has an associated subprogram, the program routine then calls the subprogram on the basis of the content of the associated memory locations. The memory locations associated with a program routine can thus affect a subprogram call. The advantage of the method is that the subprograms are called conditionally. Another advantage in this context is that the condition for calling a subprogram by virtue of the use of the memory locations associated with a program routine can be changed retrospectively at any time by reprogramming. The method is distinguished from known methods by its versatility.

In one preferred embodiment, when calling its associated subprogram, each program routine transfers at least one parameter to the subprogram. This advantageously makes the method even more versatile, since the subprogram is able to execute different functions on the basis of the transferred parameter.

In one particularly preferred embodiment, the memory locations associated with a program routine are associated exclusively with the program routine. This embodiment is used if the memory space requirement in the second read/write memory is insignificant. An advantage in this case is the great versatility for calling the subprograms, since, by virtue of appropriate use of the associated memory locations, it is possible to stipulate for each program routine whether the associated subprogram is to be called. In an alternative, particularly preferred embodiment, the memory locations associated with a program routine are also associated with all the other program routines. In this case, advantageously, very little memory space is required in the second read/write memory, since all the program routines have the same associated memory locations. In this case, however, whether the respective subprogram associated with a program routine is to be called can be stipulated, by appropriate use of the associated memory locations, only for all the program routines to the same extent.

In one particularly preferred embodiment, the parameter notifies the subprogram of the program routine that is calling, and the operation of the subprogram is influenced on the basis of this.

Other features which are considered as characteristic for the invention are set forth in the appended claims.

Although the invention is illustrated and described herein as embodied in a method for changing the execution of a program stored in a read only memory, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is an illustration of an exemplary embodiment of a stored program according to the invention; and

FIG. 2 is an illustration of an exemplary embodiment of an instance of use of the first and second read/write memories.

### DESCRIPTION OF THE PREFERRED EMBODIMENTS

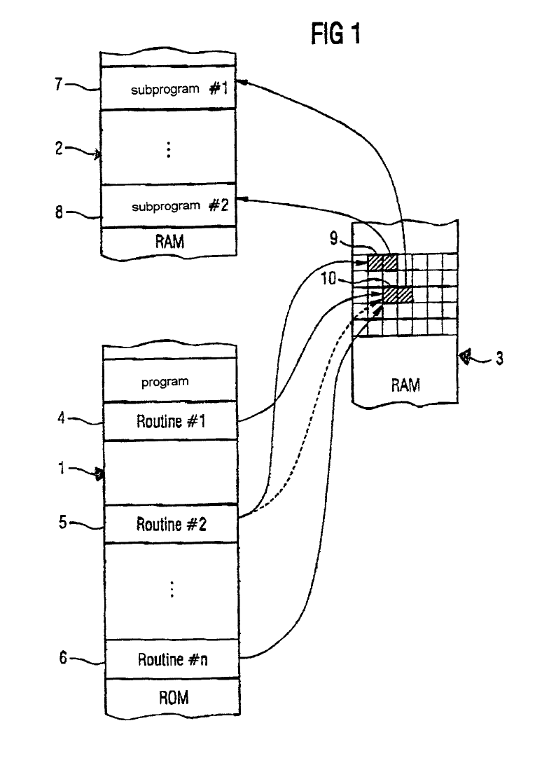

In all the figures of the drawing, sub-features and integral parts that correspond to one another bear the same reference symbol in each case. Referring now to the figures of the drawing in detail and first, particularly, to FIG. 1 thereof, there is shown a read only memory 1 storing a program. The program has a multiplicity of program routines (called routines below), with only three routines 4, 5 and 6 being shown in FIG. 1. The routines 4-6 are named routine #1 to routine #n to indicate that more than three routines may be stored in the read only memory 1. The routines are “incorporated” into the program at particular prescribed address intervals. An important aspect here is that the routines 4-6 are situated so as to be “evenly scattered” over the entire address range of the program in order that each part of the program may be changed retrospectively. If, by way of example, there are only routines in the low address range of the program, it is no longer possible to jump to subprograms from the higher address range of the program, and accordingly it is also no longer possible to make corrections in this address range. Since the routines 4, 5 and 6 are stored in the read only memory 1, the routines themselves cannot now be changed retrospectively.

Each of the routines 4 to 6 has an associated subprogram 7 to 8. In this case, the subprograms are stored in a first read/write memory 2 and can be changed retrospectively at any time. The first read/write memory 2 occupies the same address space as the read only memory 1, in which the program is stored. Therefore, both the first read/write memory 2 and the read only memory 1 are driven via the same address bus and data bus and occupy the program memory range. In this case, by way of example, the first read/write memory 2 may occupy the address space from Hex 0000 to Hex 1FFF, and the read only memory 1 may occupy the address space from Hex 2000 to Hex FFFF. The read/write memory 1 can be provided by a RAM having 8192 bytes in this case.

In a second read/write memory 3, each routine 4-6 has a respective associated plurality of memory locations. The second read/write memory 3 occupies a different address space than the read only memory 1 and the first read/write memory 2. By way of example, the second read/write memory 3 may occupy the address space of a data memory. FIG. 1 shows that the routines 4 and 6 have the same associated memory locations 10, while the routine 5 has an associated memory location 9. The dashed line shows that the routine 5 can also be allocated the memory locations 10 associated with the routines 4 and 6. In this case, all the routines 4 to 6 have the same associated memory locations. Therefore, the memory space requirement in the second read/write memory 3 is low.

For the association between the routines 4-6 and the subprograms 7, 8, a distinction may be drawn between three different cases, the advantages and disadvantages of which are illustrated in the table below:

| | Association | Advantages | Disadvantages |
|---|---|---|---|
| 1 | A subprogram is | Subprogram | Second |
| | exclusively | small: it needs | read/write |
| | associated with | to handle only | memory large: |
| | one routine: | the case of the | size = “number |
| | there are the | calling routine | of subprograms” |
| | same number of | | times “memory |
| | subprograms as | | cells provided |
| | routines | | per subprogram” |
| 2 | A subprogram is | Subprogram | Second |
| | associated with | medium-sized: it | read/write |
| | a plurality of | needs to handle | memory medium- |
| | routines: there | the case of a | sized |
| | are fewer | plurality of | |
| | subprograms than | calling routines | |
| | routines | | |
| 3 | A subprogram is | Subprogram | Second |
| | associated with | large: it needs | read/write |
| | all the | to handle the | memory small |
| | routines: there | case of every | |
| | are a | calling routine | |
| | multiplicity of | | |
| | routines and one | | |
| | subprogram | | |

In the first case, although the greatest versatility is achieved, this is at the cost of a high memory space requirement in the second read/write memory.

In the second case, a balance is achieved between the memory space requirement in the second read/write memory 3 and in the first read/write memory 2 and the versatility, since a plurality of routines have the same memory locations in the second read/write memory 3 and one subprogram associated with them. The subprogram serves a plurality of calling routines and is accordingly more complex than a subprogram that serves only one routine. To distinguish the calling routines, parameters are transferred to the subprogram.

In the third case, there is only one subprogram, which serves all the routines and is accordingly large and complex. Only a minimum amount of memory space is used for this in the second read/write memory 3.

The routines 4 to 6 each have a short program sequence (macro) which reads from the second read/write memory 3 values from the memory cells associated with the respective routine and compares them with a prescribed value. On the basis of the result of the comparison, the macro then calls a subprogram stored in the first read/write memory 2. When the subprogram is called, a parameter is transferred to the subprogram.

An exemplary embodiment of the macro in a machine language reads as follows, for example:

.MACRO FW_HOOK_PAR HOOK_ID, HOOK_PAR

mov [##HK_XS.mem + HOOK_ID], a0
brr > %no_hook, eq
mov #HOOK_PAR, all
call a01

%no_hook:
.ENDM

The content of the address [##HK_XS.mem+HOOK_ID] is read into a first accumulator a0 from the second read/write memory 3. If the value which is read is equal to zero, then execution jumps to the end of the macro with brr >% no_hook, eq. A subprogram is not called in this case. Otherwise, the parameter HOOK_PAR is written to a second accumulator all and the subprogram associated with the macro is called with call a01.

The values stored in the second read/write memory 3 can correspond to the start addresses of the subprograms.

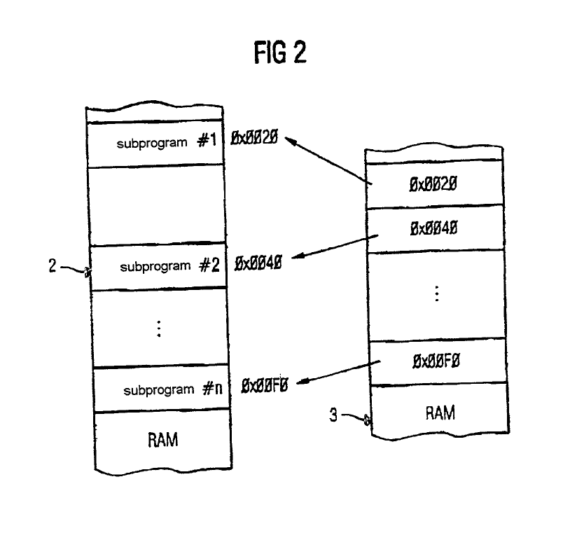

In FIG. 2, a lower addresses Hex 0000 to Hex 001F in the first read/write memory 2 are not occupied by subprograms. A first subprogram #1 starts at the address Hex 0020, a second subprogram #2 starts at the address Hex 0040, and a last subprogram #n starts at the address Hex 00F0.

The second read/write memory 3 stores the start addresses Hex 0020, Hex 0040 and Hex 00F0 of the subprograms directly.

A routine reads from the associated memory locations of the second read/write memory 3 the address stored there, compares this address with zero and uses the address, if it is not equal to zero, directly as a jump address to the subprogram stored in the first read/write memory 2.

If a routine has no associated subprogram, Hex 0000 is simply stored in the associated memory cells of the second read/write memory 3.

When a subprogram is called, one or more parameters can be transferred. This is particularly advantageous if a plurality of program routines have the same associated memory locations storing the address of a subprogram, and the subprogram is meant to execute a function corresponding to the calling program routine. In this case, the called subprogram needs to recognize the calling program routine. For this purpose, the subprogram evaluates the transferred parameter(s), with each program routine that is able to call the subprogram having a particular parameter value permanently associated with it.

The method outlined can be advantageously used with Harvard architectures, in particular, which are predominantly used for digital signal processors (DSP=Digital Signal Processor) and have separate address spaces for programs and data.

We claim:

1. A method for changing an execution of a program, which comprises the steps of:
providing a read only memory having the program stored therein, the program having a multiplicity of program routines and each of the program routines can be allocated a subprogram stored in a first read/write memory, each of the program routines having associated memory locations located in a second read/write memory, and if a respective program routine has an associated subprogram, the respective program routine calls the associated subprogram on a basis of a content of the associated memory locations.

2. The method according to claim 1, which comprises transferring at least one parameter from the respective program routine to the associated subprogram when calling the associated subprogram.

3. The method according to claim 1, wherein the associated memory locations associated with the respective program routine are associated exclusively with the respective program routine.

4. The method according to claim 1, wherein the associated memory locations associated with the respective program routine are also associated with all other ones of the program routines.

5. The method according to claim 2, wherein the parameter notifies the associated subprogram that the respective program routine is calling, and an operation of the associated subprogram is influenced on a basis of the parameter.

6. A method for changing an execution of a program, which comprises the steps of:
providing a read only memory having the program stored therein, the program having a multiplicity of program routines;
allocating each of the program routines a subprogram stored in a first read/write memory;
allocating each of the program routines associated memory locations located in a second read/write memory; and
calling the subprogram on a basis of a content of the associated memory locations.
